(19) United States
(12) Patent Application Publication
(10) Pub. No.: US 2003/0116621 A1
(43) Pub. Date: Jun. 26, 2003

(54) Self-service terminal

(75) Inventor: Ross W. Duncan, Blairgowrie (GB)

Correspondence Address: MICHAEL CHAN, NCR CORPORATION, 1700 SOUTH PATTERSON BLVD, DAYTON, OH, 45479-0001, US

(73) Assignee: NCR Corporation

(21) Appl. No.: 10/294,950

(22) Filed: Nov. 14, 2002

(30) Foreign Application Priority Data
Dec. 20, 2001 (GB) 0130479.9
Jan. 22, 2002 (GB) 0201326.6

(51) Int. Cl. G06F 17/60

(52) U.S. Cl. 235/379

(57) ABSTRACT

A self-service terminal (10) is described. The terminal, which may be an ATM, comprises a plurality of modules (14 to 34), and has a control application for controlling the operation of the terminal. The control application comprises a plurality of module driver agents (70), a plurality of module function request agents (72) for requesting functions provided by a module (14 to 34), and a logic engine (66). An interface (76) is provided between the driver agents (70) and the function request agents (72), so that a module driver agent (70) is operable to co-operate with an associated function request agent (72) to provide module functions for the logic engine (66).

### BACKGROUND OF THE INVENTION

The present invention relates to a self-service terminal (SST), such as an automated teller machine (ATM).

ATMs are public access terminals that provide users with a secure, reliable, and convenient source of cash and other financial transactions in an unattended environment.

An ATM typically comprises a panelled chassis housing a plurality of interconnected modules for performing user interface, transaction, and management functions for the ATM. Typical user interface modules include a display module, a keypad module, and a card reader module; typical transaction modules include a cash dispenser module, and a statement printer module; and typical management modules include a controller module, a communications module, and a journal printer module.

The ATM controller module has an ATM controller application program including software drivers for the modules in the ATM, and ATM controller software to manage:

(1) fault prediction and tolerance (state of health) for the ATM modules;

(2) secure communications between the controller module and other modules, and between the ATM and a remote transaction authorisation server;

(3) transaction flow, business logic, and presentation of information to an ATM user or an ATM servicer.

As a result, the ATM controller application tends to be a large, monolithic application that is specifically configured for the particular modules present in that ATM.

Adding a new module to the ATM involves re-configuring the ATM controller application by adding:

(1) an appropriate driver for the new module,

(2) any application software required by the new module; and

(3) supporting system software updates, such as diagnostics, screens, and such like.

Furthermore, the transaction flow, business logic, error handling routines, and other routines may have to be updated because of the new module. This makes adding a new module a complex and time-consuming task.

### SUMMARY OF THE INVENTION

It is among the objects of an embodiment of the present invention to obviate or mitigate one or more of the above disadvantages, or other disadvantages associated with prior art self-service terminals.

According to a first aspect of the present invention there is provided a self-service terminal comprising a plurality of modules, the terminal having a control application, characterised in that the control application comprises a plurality of independent module control agents, and a logic engine; where each module control agent is able to request and manage functions provided by an associated module, so that the logic engine can execute a transaction by issuing successive requests to module control agents.

Preferably, each module control agent comprises a module driver agent and a module function request agent. The module driver agent being operable to translate between module specific commands and information, and generic commands and information; and the module function request agent being operable to translate logic engine requests to generic commands.

Examples of generic commands relating to printing a page include: “set margin”, “font style”, “font size”, and such like. An example of a generic command relating to cash dispensing is “dispense ten pounds”.

Module specific commands are commands that are specific to one make of module. For example, one printer manufacturer uses different printer commands to another printer manufacturer. The commands used may even vary between different models supplied by the same manufacturer.

Examples of logic engine requests include: “print statement”; “dispense ten pounds”;

“print receipt”; and such like. Typically, the logic engine sends a logic engine request together with any relevant data. For example, the logic engine request “print statement” is sent together with data to be used in preparing the statement. The printer module function request agent stores information about how a statement should be printed, for example, margin size, font size, font type, and such like.

According to a second aspect of the present invention there is provided a self-service terminal comprising a plurality of modules, the terminal having a control application, characterised in that the control application comprises a plurality of module driver agents, a plurality of module function request agents for requesting functions provided by a module, and a logic engine; where an interface is provided between the driver agents and the function request agents, so that a module driver agent is operable to co-operate with an associated function request agent to provide module functions for the logic engine.

By virtue of this aspect of the invention, independent, autonomous, code is used to implement each module driver and each module function request. This enables any agent (for example, a driver agent or a function request agent) to be updated, added, or removed, without affecting any other agent in the terminal. A driver pairs with an associated function request across the interface to make the functions of a module available to the terminal.

As referred to herein, an “agent” is a software entity comprising code, and optionally data, that can be used to perform one or more operations in a computing environment. An agent performs operations with some degree of independence and autonomy, and presents a consistent interface to other software entities, such as other agents.

Preferably, health agents are provided and co-operate with driver and function agents. Health agents are operable to record state of health information, such as the state of sensors in a module, and may provide some degree of fault prediction.

Preferably, the logic engine is implemented by an agent having access to a set of rules. The rules may be provided in any convenient form. Suitable artificial intelligence rules may be based on: an artificial neural network (ANN), an expert system, a fuzzy logic system, or such like. Alternatively, the logic engine may be implemented by a group, or community, of agents.

Preferably, the interface between agents is implemented by a broker agent. In an alternative embodiment, one broker agent is associated with the driver agents, and one broker agent is associated with the function request agents.

The driver agents may be organised in a community of agents that register their functions with a broker agent. The function request agents may also be organised in a community of agents that register with the broker agent.

Preferably, a gatekeeper agent is provided for monitoring any user accessible communications channel, which may be implemented by, for example, a Bluetooth (trade mark) transceiver, an IrDA transceiver, an 802.11b transceiver, or such like. The gatekeeper agent performs security checks on any request by a user to communicate via the communications channel. If the security check is passed, then the gatekeeper agent invokes a driver agent to represent the user.

According to a third aspect of the present invention there is provided a method of operating a self-service terminal comprising a plurality of modules, and having a control application, the method being characterised by the steps of: providing a plurality of module driver agents, each module driver agent being operable to instruct a module to perform one or more functions; providing a plurality of module function request agents for requesting functions provided by a module; providing a logic engine; and teaming a driver agent with a function request agent via an interface to provide module functions for the logic engine.

By virtue of this aspect of the present invention, a community of driver agents can be established, and a community of function request agents can be established, so that the driver and function request agents can co-operate on a one-to-one basis to instruct a module to perform one or more functions. This has the advantage that if a new module is added to the terminal, a new driver agent can be added to the driver agent community, and a new function request agent can be added to the function request agent community, and the new agents cooperate to provide the new functions of the module. If a module is replaced with the same type of module but manufactured by a different company, a new driver agent can be added, without having to change the associated function request agent. This agent architecture simplifies the task of adding, removing, and updating modules in the terminal.

### BRIEF DESCRIPTION OF THE DRAWINGS

These and other aspects of the present invention will be apparent from the following specific description, given by way of example, with reference to the accompanying drawings, in which:

FIG. 1 is schematic diagram of the architecture of a self-service terminal according to one embodiment of the present invention;

FIG. 2 is a schematic diagram showing the software architecture of a control application executing in memory of the terminal of FIG. 1;

FIG. 3 is a schematic diagram of a driver agent of the control application of FIG. 2;

FIG. 4 is a schematic diagram of a function request agent of the control application of FIG. 2;

FIG. 5 is a schematic diagram of a health agent of the control application of FIG. 2;

FIG. 6 is a schematic diagram of a broker agent of the control application of FIG. 2; and

FIG. 7 is a schematic diagram of an agent environment according to another embodiment of the present invention.

### DETAILED DESCRIPTION

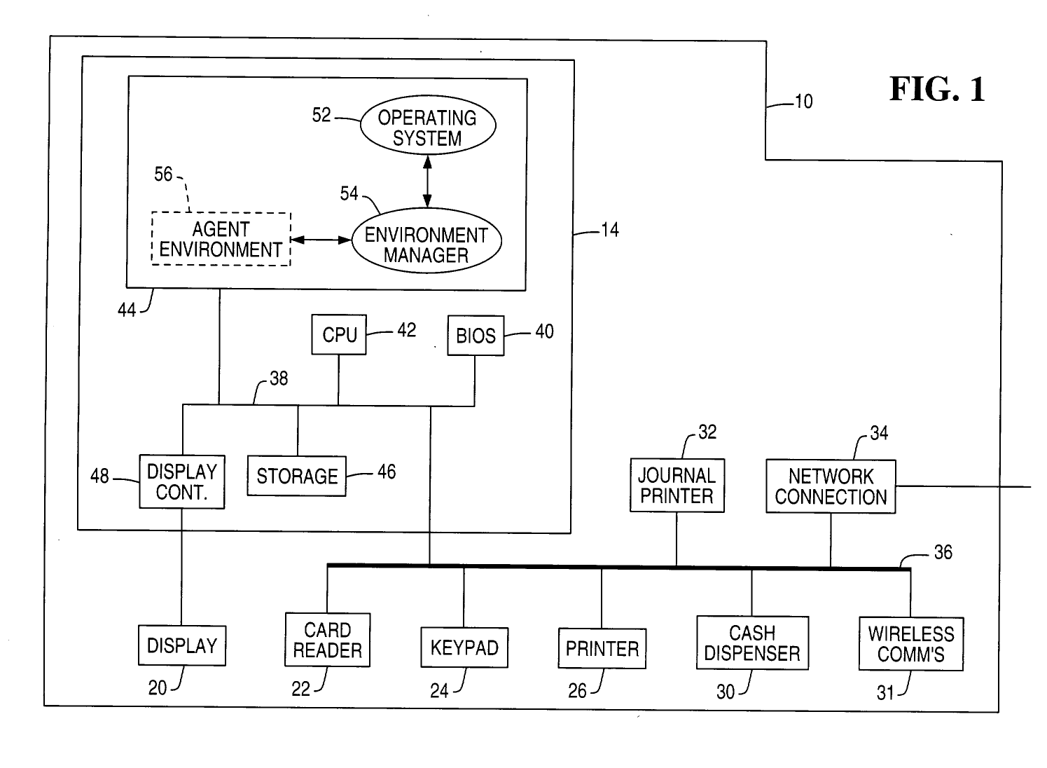

Reference is first made to FIG. 1, which is a simplified block diagram of the architecture of an SST 10, in the form of an ATM, according to one embodiment of the present invention.

The ATM 10 comprises a plurality of modules for enabling transactions to be executed and recorded by the ATM 10. These ATM modules comprise: a controller module 14, a display module 20, a card reader/writer module 22, an encrypting keypad module 24, a receipt printer module 26, a cash dispenser module 30, a wireless communication module 31 having a Bluetooth (trade mark) transceiver, a journal printer module 32 for creating a record of every transaction executed by the ATM 10, and a network connection module 34 (in the form of an enhanced network card) for accessing a remote authorisation system (not shown).

The controller 14 comprises a BIOS 40 stored in non-volatile memory, a microprocessor 42, main memory 44, storage space 46 in the form of a magnetic disk drive, and a display controller 48 in the form of a graphics card.

The display module 20 is connected to the controller module 14 via the graphics card 48 installed in the controller module 14. The other ATM modules (22 to 34) are connected to the ATM controller 14 via a device bus 36 and one or more internal controller buses 38.

When the ATM is powered up, a secure booting-up process is performed, in which the main memory 44 is loaded with an ATM operating system kernel 52, and an agent environment manager 54 in a secure manner. Furthermore, the ATM modules (20 to 34) and other components within the controller module (40,46,48) are authenticated.

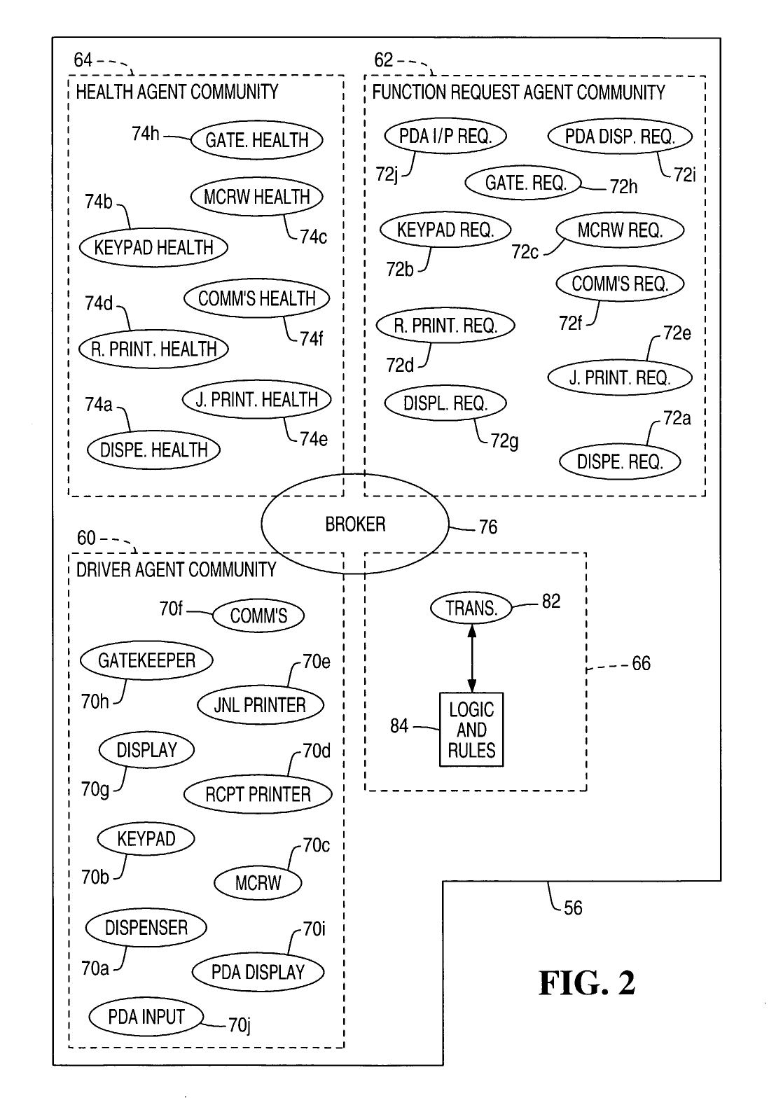

As is well known in the art, the operating system kernel 52 is responsible for memory management, process management, task management, and disk management. The agent manager 54 implements a Java Virtual Machine for allowing agents to execute within a controlled agent environment 56. The controlled agent environment 56 is illustrated in more detail in FIG. 2.

Referring to FIG. 2, the agent environment 56 includes three agent communities: a driver agent community 60, a function request agent community 62, and a health agent community 64; and a logic engine 66.

Each community 60,62,64 contains agents that can interact with other agents within that community, and with associated agents in other communities. Each community 60,62,64 also contains an agent infrastructure to instantiate agents and to allow agents to execute.

The Driver Agent Community

The driver agent community 60 includes a driver agent 70 for each module in the ATM 10 (apart from the controller module 14), namely: a dispenser driver agent 70a, a keypad driver agent 70b, a card reader driver agent 70c, a receipt printer driver agent 70d, a journal printer driver agent 70e, a network card driver agent 70f, a display driver agent 70g, and a gatekeeper driver agent 70h for the wireless communications module 31. The driver agent community 60 also includes a small display agent 70i and a wireless input agent 70j for outputting information to and receiving information from a wireless device that may be used by an ATM user for entering a transaction at the ATM. The small display agent 70i renders information for viewing on a small display, such as a display incorporated into a cellular radio-frequency telephone (hereinafter a “cellphone”), a personal digital assistant (PDA), or such like. The wireless input agent 70j receives user entries from the cellphone or PDA.

The gatekeeper driver agent 70h monitors information transmitted from a user's wireless device, and will be described in more detail below.

Each of these driver agents 70 translates generic commands to hardware-specific low-level commands for operating the associated module. Most of the drivers 70 also report status information from sensors or other indicators in their associated modules. In this embodiment the display module 20 does not include any sensors, so the display driver agent 70g does not report status information. For similar reasons, the small display agent 70i does not report sensor status information either. However, it may report non-sensor information, such as configuration information, for example number of lines that can be displayed.

The driver agent community 60 accesses a broker agent 76 that performs administrative tasks, as will be described in more detail below. The broker agent 76 is not a driver agent 70 and is not part of the driver agent community 60, but the broker agent 76 is shown overlapping the community 60 in FIG. 2 because the broker agent 76 stores information about the driver agents.

The Function Request Agent Community

The function request agent community 62 includes a function request agent 72 for each module in the ATM 10 (apart from the controller module 14), namely: a dispenser function request agent 72a, a keypad function request agent 72b, a card reader function request agent 72c, a receipt printer function request agent 72d, a journal printer function request agent 72e, a network card function request agent 72f, a display function request agent 72g, and a gatekeeper function request agent 72h. The function request agent community 62 also includes a function request agent for outputting information to a wireless device, referred to as a small display function request agent 72i, and a function request agent for receiving information from a wireless device, referred to as a wireless input function request agent 72j.

The function request agent community 62 also accesses the broker agent 76. The broker agent 76 is not a function request agent 72 and is not part of the function request agent community 62, but the broker agent 76 is shown overlapping the community 62 in FIG. 2 because the broker agent 76 provides information to the function request agents 72.

Each of the function request agents 72 translates generic commands from the logic engine 66 to a format suitable for an associated driver agent 70, so that the function request agents 72 provide a consistent interface to the logic engine 66. An associated driver agent is a driver agent that provides suitable functions for the function request agent; for example, a dispenser driver agent is an associated driver agent for a dispenser function request agent.

The function request agents 72 also provide additional features for the logic engine 66 (for example, obtaining information from the driver agents 70 about the capabilities of the modules, the configuration of the modules, and such like).

The Health Agent Community

The health agent community 64 comprises a health agent 74 for each module in the ATM 10 (apart from the controller module 14 and the display module 20), namely: a dispenser health agent 74a, a keypad health agent 74b, a card reader health agent 74c, a receipt printer health agent 74d, a journal printer health agent 74e, a network card health agent 74f, and a gatekeeper health agent 74h.

Each health agent 74 collates and stores status information for its associated driver agent 72. The health agent community 64 also accesses the broker agent 76. The broker agent 76 is not a health agent 74 and is not part of the health agent community 64, but the broker agent 76 is shown overlapping the community 64 in FIG. 2 because the broker agent 76 provides information to the health agents 74.

The Logic Engine

The logic engine 66 comprises a transaction flow agent 82 and an associated rules and business logic file 84, where the transaction flow agent 82 accesses the file 84 to control the operation of the ATM 10, as will be described in more detail below.

The rules and business logic file 84 contains the rules that govern the operation of the ATM 10. Examples of rules include the following: the number of digits in a user's PIN (personal identification number), the number of incorrect PIN entries a user is allowed before the ATM captures the user's card; the maximum amount of money that may be withdrawn each day; when the ATM offers receipts, for example, at off-peak hours; when certain transactions are available, for example, funds transfers may only be allowed during certain off-peak hours, and such like.

The rules and business logic file 84 also contains the transaction flow, that is, the sequence of screens presented to a user at the ATM 10. The term “screen” is used herein to denote the graphics, text, controls (such as menu options), and such like, that are presented on the ATM display; the term “screen” as used herein does not refer to the hardware (that is, the display) that presents the graphics, text, controls, and such like. Typically, when a transaction is being entered at an ATM, a series of screens are presented in succession on the display, the next screen displayed being dependent on a user entry or activity relating to the current screen. For example, a first screen may request a user to insert a card; once a card has been inserted a second screen may invite the user to enter his/her PIN; once the final digit of the PIN has been entered, a third screen may invite the user to select a transaction; and so on.

The transaction flow agent 82 accesses the function request agents 72 to determine what ATM functions are available and uses this information and the information from the rules and business logic file 84 to prepare screens having transaction options consistent with the ATM functions currently available.

The rules and business logic file 84 may be a static file containing rules, or it may be an executable file.

Driver Agent

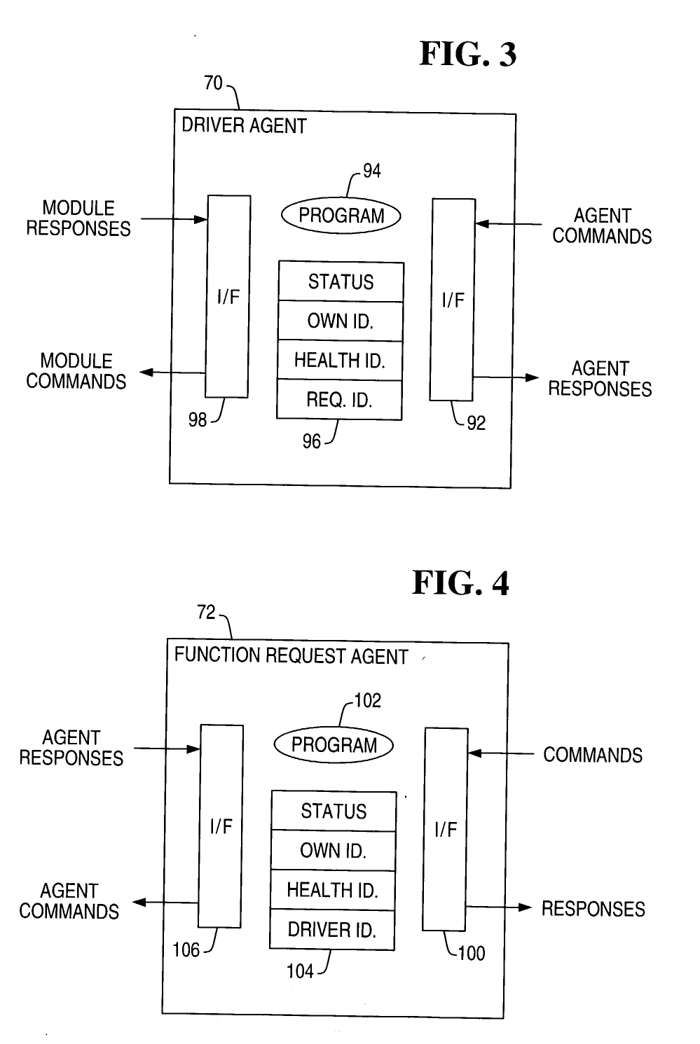

A typical driver agent 70 is illustrated in FIG. 3. The agent 70 has an agent interface 92, an operation program 94, a data storage area 96, and a module interface 98.

The agent 70 receives commands from other agents and sends responses and status information to other agents via the agent interface 92. Every driver agent 70 has the same agent interface 92. For example, a command may be defined as a three digit hexadecimal code, and different codes are used for operations and functions relating to each module type. Each driver agent 70 can recognise and translate codes relating to operations it must perform.

The operation program 94 is the part of the agent that performs the translation of instructions and information between a generic format and a module specific format.

The data storage area 96 stores status information and address information. The status information includes, for example, whether the module is operational or not, any faults in the module, and such like. The address information stores a contact identifier for the agent (that is, for itself) and contact identifiers for other agents it communicates with, namely, an associated function request agent 72, and an associated health agent 74.

The agent 70 sends commands to and receives responses from its associated module via the module interface 98. The agent 70 may interact directly with its associated module, or it may interact with its associated module via another driver provided by the module's manufacturer.

Function Request Agent

A typical function request agent 72 is illustrated in FIG. 4. The agent 72 has a logic engine interface 100, an operation program 102, a data storage area 104, and an agent interface 106.

The agent 72 receives commands from the logic engine 66 and sends responses and status information to the logic engine 66 via the logic engine interface 100.

The operation program 102 is the part of the agent 72 that translates commands received from the logic engine 66 into commands for an associated driver agent 70, and manages the performance of the associated driver agent 70, for example, to ensure that a requested task is performed, or if the requested task cannot be performed after a predetermined number of attempts to determine what parts of the task, if any, were performed.

The data storage area 104 stores status information and address information. The status information includes, for example, whether the associated module is operational or not, what functions the module can perform, what features the module can support, and such like. The address information stores a contact identifier for the agent (that is, its own contact identifier) and contact identifiers for other agents it communicates with, namely, an associated driver agent 70, and an associated health agent 74.

The agent 72 sends commands to and receives responses from its associated driver agent 70, and the driver agent's associated health agent 74, via the agent interface 106.

For the purposes of clarity, each of the agents 70,72 shown in FIGS. 3 and 4 is illustrated as having two interfaces; however, in each of these agents, the two interfaces may be implemented by a single interface.

Health Agent

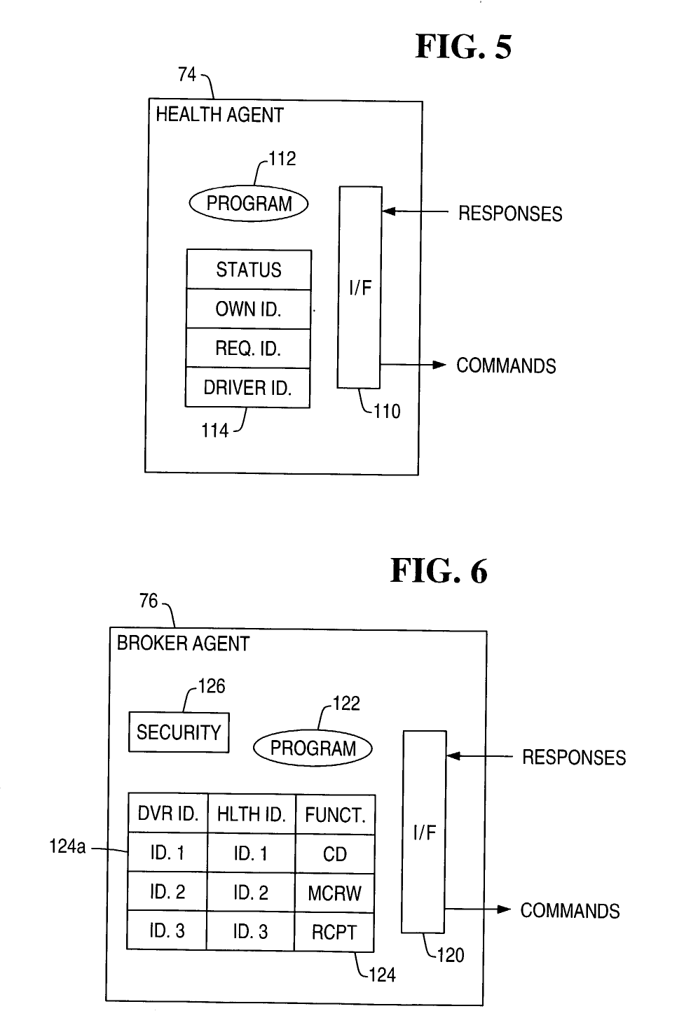

A typical health agent 74 is illustrated in FIG. 5. The agent 74 has an agent interface 110, an operation program 112, and a data storage area 114.

The agent 74 issues requests for information to, and receives responses and status information from, an associated driver agent 70 via the agent interface 110. The agent 74 also sends status information to an associated function request agent 72 via the agent interface 110.

The operation program 112 operates on the status information, for example, to predict faults and determine the operational status of the associated module.

The data storage area 114 stores status information and address information. The status information includes, for example, the state of sensors or other indicators within the module, previous faults, a log of status reports, and such like. The address information stores a contact identifier for the agent (that is, its own contact identifier) and contact identifiers of other agents it communicates with, namely, an associated driver agent 70, and an associated function request agent 72.

Broker Agent

The structure of the broker agent 76 is illustrated in FIG. 6. The broker agent 76 comprises an agent interface 120, an operation program 122, a register 124, and a security validator 126.

The broker agent 76 sends and receives information via the interface 120.

The security validator 126 is used to verify that a driver seeking registration is an authentic driver, which may be implemented using a signed digital certificate or such like.

The register 124 lists the identifiers of driver agents 70 that are present and have been authenticated, together with a standardised description of their function, for example, “cash dispenser”, “receipt printer”, and such like. The register also stores identifiers of health agents 74 and function request agents 72 associated with the authenticated driver agents 70.

ATM Operation

The operation of the ATM 10 will now be described with reference to FIGS. 1 to 6.

Initially, when the ATM 10 is powered up, the controller module 14 loads its memory 44 with the operating system kernel 52 and the agent environment manager 54, as described above.

The environment manager 54 then instantiates in a predetermined order the agents within the communities 60,62,64, the broker agent 76, and the transaction flow agent 82.

Driver Community Initiation

The driver community 60 is instantiated first. When the driver agents 70 in the driver agent community 60 are instantiated, each agent 70 attempts to detect an associated module in the ATM 10. Thus, when the cash dispenser agent 70a is instantiated it attempts to locate a cash dispenser module within the ATM 10. As the cash dispenser module 30 is present in the ATM 10, and has been authenticated by the controller module 14 during the boot-up sequence, the cash dispenser agent 70a detects the cash dispenser module 30 and registers with the broker agent 76.

In registering, the cash dispenser driver agent 70a provides its own identifier to the broker 76 and provides authentication details to enable the broker 76 to verify that the cash dispenser agent 70a is valid. The authentication details may comprise a digital signature or such like that is compared with a signature in the security validator 126. If the broker 76 is satisfied that the cash dispenser agent 70a is valid, then the broker 76 adds the identifier and function of the cash dispenser agent 70a to the register 124 stored within the broker 76 to create a cash dispenser entry 124a.

Any driver agents 70 that cannot locate an associated module in the ATM 10 within a predetermined time period, for example one minute, terminate and take no further part in the driver community 60.

Thus, after a short period of time, the broker agent 76 contains a list of the driver agents 70 present that have been authenticated and that have an associated module. For each driver agent 70 in this list, the broker agent 76 contains a contact identifier.

Health Community Initiation

The health agents 74 are instantiated a predetermined period of time after the driver agents 70 are instantiated (for example, one minute).

When the health agents 74 in the health agent community 64 are instantiated, each agent (for example card reader agent 74c) registers with the broker 76 by providing its contact identifier and its function (for example, card reader health agent), and requests a contact identifier for an associated driver agent, for example, a card reader health agent 74c requests a contact identifier for a card reader driver agent 70c. For each health agent 74 associated with a registered driver agent 70, the broker 76 stores the health agent's contact identifier in register 124. Those health agents 74 not having an associated driver agent 70 terminate.

For the card reader example, the broker agent 76 accesses the register 124, and searches the function fields for a card reader.

If no card reader driver agent 70c is present, then the broker 76 informs the card reader health agent 74c that no contact identifier can be provided.

If a card reader driver agent 70c has registered with the broker agent 76, then the broker 76 provides the card reader health agent 74c with the contact identifier of the card reader driver agent 70c from the register 124.

Using this identifier, the card reader driver agent 70c can communicate directly with the card reader health agent 74c.

Thus, after a short period of time, the health agent community 64 contains health agents 74 that have paired with associated driver agents 70.

Transaction Flow Agent Initiation

When the transaction flow agent 82 is instantiated, which typically occurs at approximately the same time as the driver agents 70 are instantiated, the transaction flow agent 82 waits for a predetermined period of time (for example, one minute) to allow the broker agent 76 to populate the register 124 with contact identifiers for authenticated driver agents 70 having associated modules in the ATM 10.

The transaction flow agent 82 accesses the rules and business logic file 84 to determine what transactions are to be offered. For example, at certain times of a day, or on certain days of a week, only a limited set of transactions may be offered, such as cash dispensing only.

The transaction flow agent 82 then determines the modules that are required for the ATM 10 to be able to provide the transactions to be offered. The transaction flow agent 82 then instantiates function request agents 72 for each of these required modules.

Thus, if cash dispensing is the only transaction to be offered, then the transaction flow agent 82 determines that the following modules are required: display 20, card reader 22, keypad 24, cash dispenser 30, journal printer 32, and network connection 34.

For this example, the transaction flow agent 82 instantiates the display function request agent 72g, the cash dispenser function request agent 72a, the keypad function request agent 72b, the cash dispenser function request agent 72a, the journal printer function request agent 72e, and the network card function request agent 72f. The transaction flow agent 82 may instantiate the function request agents directly, or may instruct the broker 76 to instantiate the function request agents.

If the transaction flow agent 82 intended to offer additional transaction options, but one or more modules needed to implement those options was unavailable, then the transaction flow agent 82 would determine what transaction options, if any, could be offered.

This is achieved by comparing the list of available modules with rules contained in the file 84. For example, the rules may indicate that if no network communication module is present, then no transactions can be offered; if no journal printer module is present, then no transactions can be offered; if a cash dispenser is not present, then no transactions can be offered unless a statement printer is present; and such like. These rules are analogous to rules currently used in ATM transaction flow programs.

Any function request agents 72 that do not have an associated driver agent 70 in the register 124 enter an unused but available state. In this unused but available state, the function request agent 72 requests the broker 76 to be informed if an associated driver agent 70 registers, so that if such a driver agent 70 is subsequently added, the agent 72 can form an associated function request and driver pair.

Example of a Transaction

A typical transaction will now be described. In this example, the rules file 84 indicates that cash dispensing, receipt printing, and account balance enquiries are to be offered by the ATM 10. The transaction flow agent 82 instantiates the appropriate function request agents 72a to 72g, and they pair with associated driver agents 70a to 70g. In this example, the modules present in the ATM 10 support cash dispensing, receipt printing, and account balance enquiries, so these transactions can be offered.

Attraction Screen

The transaction flow agent 82 sends an attraction screen to the display function request agent 72g. The function request display agent 72g sends a display command and screen data to the driver display agent 70g via agent interfaces 106 and 92. The display command instructs the driver agent 70g to display the screen data. The driver's operation program 94 implements this command by transferring the screen data to the graphics card 48 for presentation on the display module 20. The driver's operation program 94 then informs the function request agent 72g via agent interfaces 92 and 106 that the command was implemented successfully.

The screen data includes the text “Please enter your card”, and may include some animation or video sequences. The ATM 10 presents this attraction screen and awaits insertion of a user's card.

Card Reading Stage

A user enters her card into the card reader module 22. The card reader module 22 draws in the user's card and reads data from a magnetic stripe carried by the user's card. The read data includes an account number, card issuer information, expiry date information, and the cardholder's name. The module 22 conveys this read data to the card reader driver agent 70c, which conveys this data to the card reader function request agent 72c in a standard format. The function request agent 72c extracts the account number and card issuer information and conveys these to the transaction flow agent 82.

PIN Entry Stage

The transaction flow agent 82 creates a PIN entry screen requesting the user to enter a PIN, and sends the PIN entry screen to the display function request agent 72g, which sends a display command and the PIN entry screen data to the display driver agent 70g. The driver agent's operation program 94 implements this display command and informs the function request agent 72g that the display command was implemented successfully.

When the user sees the PIN screen, she enters her four digit PIN. The encrypting keypad module 24 receives this PIN, encrypts it, and sends it to the keypad driver agent 70b. The driver agent 70b conveys this PIN to the function request agent 72b in a standard format. The function request agent 72b conveys this PIN to the transaction flow agent 82.

Transaction Selection Stage

The transaction flow agent 82 creates a transaction selection screen requesting the user to select from a transaction option listed. The transaction options listed are determined by the modules present in the ATM 10 and the rules and business logic file 84. As mentioned above, the transaction options available in this embodiment are cash withdrawal without receipt, cash withdrawal with receipt, and balance enquiry.

The transaction flow agent 82 sends the transaction selection screen to the display function request agent 72g, which sends a display command and the transaction selection screen data to the display driver agent 70g.

The driver agent's operation program 94 implements this display command and informs the function request agent 72g that the display command was implemented successfully.

The user selects the “Cash withdrawal without receipt” option using encrypting keypad module 24. The encrypting keypad module 24 conveys this keypad entry to the keypad driver agent 70b. The driver agent 70b conveys this entry to the function request agent 72b in a standard format. The function request agent 72b conveys this entry to the transaction flow agent 82, which determines that the “Cash withdrawal without receipt” option has been selected.

Transaction Amount Stage

The transaction flow agent 82 creates an amount entry screen requesting the user to enter a number corresponding to an amount of money to be withdrawn from an account. In creating this screen, the transaction flow agent 82 accesses the cash dispenser function request agent 72a to query what denominations of bank notes are available.

When the cash dispenser function request agent 72a pairs with the cash dispenser driver agent 70a, the function request agent 72a asks the driver agent 70a to provide information on the denominations of bank notes that are available. In this example, the cash dispenser 30 is configured for storing ten pound notes and twenty pound notes; however, the cash dispenser has dispensed all of its ten pound notes. When the supply of ten pound notes is exhausted, the cash dispenser driver agent 70a informs the cash dispenser function request agent 72a that only twenty pound notes are available.

Thus, when the transaction flow agent 82 accesses the cash dispenser function request agent 72a, the transaction flow agent 82 is informed that only twenty pound notes are available.

The transaction flow agent 82 creates a transaction amount screen including text stating that only multiples of twenty pounds can be dispensed.

The transaction flow agent 82 then sends the amount entry screen to the display function request agent 72g, which sends a display command and the amount entry screen data to the display driver agent 70g. The driver agent's operation program 94 implements this display command and informs the function request agent 72g that the display command was implemented successfully.

When the user sees the amount entry screen, she enters the amount of money she would like to withdraw (in this example forty pounds) using the encrypting keypad module 24. The encrypting keypad module 24 detects the sequence of keys pressed (a four and then a zero) and sends it to the keypad driver agent 70b. The driver agent 70b conveys the number (forty) corresponding to the sequence of keys pressed (four then zero) to the function request agent 72b in a standard format. The function request agent 72b conveys this number (forty) to the transaction flow agent 82.

The transaction flow agent accesses the rules and business logic file 84 to determine if the number is a valid number, for example, if it is less than the maximum amount that may be withdrawn in a single transaction. In this example, forty pounds is a valid cash withdrawal request because it meets the criteria of the rules and business logic file 84 and is a multiple of twenty pounds.

Transaction Authorisation Stage

The transaction flow agent 82 creates a transaction authorisation screen requesting the user to wait while the transaction is being authorised, and sends this screen to the display function request agent 72g, which sends a display command and the transaction authorisation screen data to the display driver agent 70g. The driver agent's operation program 94 implements this display command and informs the function request agent 72g that the display command was implemented successfully.

The transaction flow agent 82 also creates a PIN block for sending to a remote authorisation system (not shown). The PIN block is an encrypted string containing the account number, card issuer information, the PIN, and the amount of cash requested.

The transaction flow agent 82 sends the PIN block to the network card function request agent 72f for conveying to the remote authorisation system (not shown). The request agent 72f sends the PIN block to the network card driver agent 70f, which conveys the PIN block to the remote authorisation system (not shown). If, for example, the communication fails, then the network driver agent 70f informs the network function request agent 72f that there has been a failure in transmission of the PIN block. The network driver agent 70f then conveys the PIN block to the driver agent 70f again, and instructs the driver agent 70f to re-send the PIN block. If this second attempt fails, then the request agent 70f may report a transmission failure to the transaction flow agent 82. However, in this example, the second attempt succeeds and an authorisation approval is received from the remote authorisation system (not shown). This approval is conveyed to the transaction flow agent 82 via the network card's driver agent 70f and function request agent 72f.

The transaction flow agent 82 then instructs the cash dispenser function request agent 72a to dispense forty pounds to the user.

The cash dispenser function request agent 72a instructs the cash dispenser driver agent 70a, and the cash dispenser module 30 dispenses forty pounds. When the cash dispenser module 30 detects that the user has removed the money, it informs the driver agent 70a. The driver agent 70a then informs the function request agent 72a that the dispensing operation was successful. The function request agent 72a informs the transaction flow agent 82.

The transaction flow agent 82 creates a dispensing complete message for transmission to the remote authorisation system (not shown) so that the remote system can update its records for that account. This dispensing complete message is sent via the network card function request and driver agents 72f,70f in a similar manner as the PIN block.

The transaction being complete, the transaction flow agent 82 then creates the attraction screen for presentation on the display module in the same manner as described above.

Operation of Health Agents

The health agents operate in the background to monitor the functions of the modules. When a module, such as a cash dispenser, operates, sensors are activated in a sequence as notes are transported, shutters are opened and closed, diverter gates are activated, and such like. The dispenser health agent 74a monitors the operation of these sensors to predict possible failures and to inform a servicer (such as a replenisher or a technician) when media needs replenished or a reject bin needs emptied. This is analogous to fault prediction and management as is presently implemented by some ATMs.

If the dispenser health agent 74a detects that some service work needs to be performed, then the health agent 74a informs the dispenser function request agent 72a, which in turn requests the transaction and logic flow agent 82 to request via the network module 34 a service visit.

The agent environment 56 may include system agents that are not specific to one particular module, but monitor the health of the entire ATM at the system level, and allow fault diagnosis and tests to be executed.

Wireless User Interface

In another example, when the transaction flow agent 82 instantiates the function request agents described in the above example (72a to 72g), it also instantiates a gatekeeper function request agent 72h, a small display function request agent 72i, and a wireless input function request agent 72j. The gatekeeper function request agent 72h allows a user to enter a transaction using a wireless device; the small display function request agent 72i renders information appropriately for presentation on a small display; and the wireless input function request agent 72j receives inputs from a wireless portable device.

If a user wishes to enter a transaction using a PDA, then the user can enter the transaction via the ATM's wireless communication port 31. The gatekeeper driver agent 70h validates the user's PDA (for example, by examining a signed digital certificate transmitted by the PDA). The gatekeeper driver agent 70h then instantiates the small display driver agent 70i and the wireless input driver agent 70j, which register with the broker agent 76.

When the small display driver agent 70i registers with the broker agent 76, the broker agent 76 informs the gatekeeper function request agent 72h that the small display driver agent 70i and the wireless input driver agent 70j have been instantiated. The broker 76 also informs the small display function request agent 72i of the contact identifier of the small display driver agent 70i; and the wireless input function request agent 72j of the contact identifier of the wireless input driver agent 70j.

The wireless input driver agent 70j conveys the transaction information in a standard format to the wireless input function request agent 72j. The wireless input function request agent 72j extracts from the transaction information: a transaction request (for example, withdraw cash), a transaction amount (for example, twenty pounds), an account number, a financial institution identifier, and a PIN; and sends the extracted information to the transaction flow agent 82 for preparing a transaction authorisation request.

If the requested transaction is authorised, then the transaction flow agent 82 sends a message to the user's PDA via the small display function request and the small display driver agent 72i,70i indicating that the requested money is being dispensed. The transaction flow agent 82 sends a message to the display 20 via the display function request and driver agents 72g,70g to present a screen including text “Wireless transaction being processed” The transaction flow agent 82 also instructs the cash dispenser function request agent 72a to implement dispensing of the requested money.

It will now be apparent that the above embodiment has the advantage that the rules and business logic file 84 can be updated without affecting the transaction flow agent 82, the function request agents 72, or the driver agents 70. Similarly, one or more driver agents 70 can be modified or replaced without affecting any function request agent 72, the transaction flow agent 82, or the rules and business logic file 84. Furthermore, one or more function request agents 72 can be modified or replaced without affecting any driver agent 72, the transaction flow agent 82, or the rules and business logic file 84. This provides a simple and robust software architecture for an ATM control application.

Any errors or failures in a module executing an operation is reported to the associated function request agent 72 via the driver agent 70. The function request agent 72 can decide whether the module should retry the operation; after any retries, the function request agent 72 can provide the transaction flow agent 82 with details of the extent to which an operation was successful. This avoids the transaction flow agent having to be responsible for module management. The transaction flow agent 82 may provide a function request agent with details of how many retries or such like the function request agent should attempt before notifying the transaction flow agent 82.

Thus, the above embodiment has the advantage of separating software control of a terminal into three main layers. The first layer is the low level module control that instructs a module to perform a basic operation, this is implemented using driver agents 70. The second level is a higher level control that manages the overall operation of a module, this is implemented by the function request agents 72. The third level is the transaction flow that determines the order of, and options presented during, a transaction, this is implemented by the transaction flow agent 82. In the first two levels, the function and operation of each module is controlled by a dedicated module agent which is independent of all other module agents, thereby allowing individual module agents to be changed without affecting the other module agents.

Alternative Embodiment

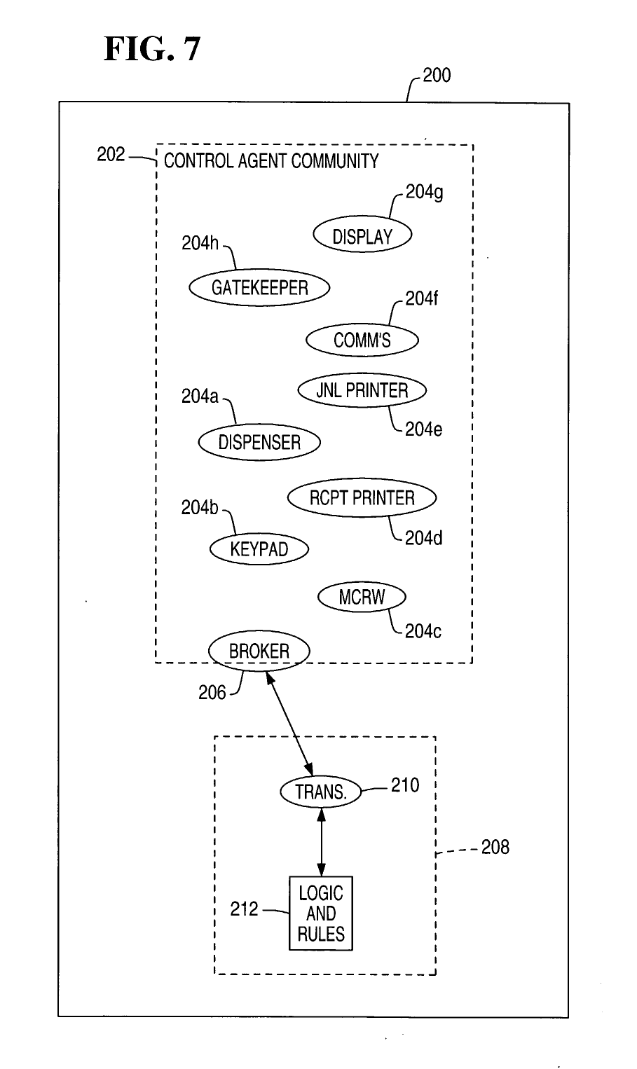

An alternative embodiment of the present invention will now be described with reference to FIG. 7, which shows an agent environment 200. The agent environment 200 is implemented on the same hardware (that is, the ATM modules) as the above embodiment.

The agent environment 200 has a module control agent community 202 comprising a module control agent 204 for each module in the ATM.

The environment also has a control agent broker 206 and a logic engine 208. The logic engine 208 comprises a transaction flow agent 210 and a rules and business logic file 212.

In this embodiment, each control agent 204 combines the functions of a driver agent, a function request agent and a health agent, from the previous embodiment. Typically, the control agent provides minimal state of health functionality, and is suitable for a low cost, low function terminal.

The control agents 204 are all initially instantiated, but only those agents that locate an associated module can register with the broker 206. The other agents are inactivated. If a new module is added, the ATM is re-booted so that the control agents have to register again.

The transaction flow agent 210 operates in a similar manner to the transaction flow agent in the first embodiment.

Various modifications may be made to the above described embodiments within the scope of the invention, for example, in other embodiments health agents may not be used. In other embodiments, an automatic module detection operation may be performed, and only those agents are instantiated for which an associated module has been detected. In the above embodiments, the agents are static, however, in other embodiments, the agents may be mobile. In other embodiments, the transaction flow agent 82 may request from the broker agent 76 a list of all driver agents 70 present, and may only instantiate those function request agents 72 having an associated driver agent 70. In other embodiments, a driver agent 70 may instantiate an associated health agent 74.

In other embodiments, the logic engine may be implemented by a community of agents. For example, one agent may perform exception handling, another agent may perform transaction flow, another agent may perform supervisor diagnostics for service personnel, and such like.

In other embodiments, the transaction flow agent may include the rules and business logic so that a single software entity performs the function of the logic engine 66.

In other embodiments, the transaction flow agent may have less responsibility; the function request agents within the function request community interact to execute a transaction, so that each agent performs its own task and advises the other agents in the community when the task has been completed. This reduces the complexity of the transaction flow agent, but requires the function request agents to be aware of their role in each transaction, in particular, the task performed by another agent that immediately precedes a task they have to perform; thus, agents are aware of their current state and their next state, and messages that determine movement from the current state to the next state.

In other embodiments, health agents not having an associated registered driver agent 70 may be allowed to execute as they may store information about a module that is no longer operational, and that information may indicate why the module is no longer operational.

In other embodiments, all of the function request agents 72 in the function request agent community 62 are instantiated. Each agent 72 attempts to detect an associated driver agent 70 in the driver agent community 60. This is performed by each agent 72 contacting the broker agent 76 and querying whether an associated driver agent 70 has been registered. Typically, each function request agent 72 waits for a short time period before contacting the broker agent 76 to allow the register 124 to be populated. For example, a cash dispenser function request agent 72a contacts the broker agent 76 to determine if a cash dispenser driver agent 70a has registered. The broker 76 accesses the register 124, and searches the function field for a cash dispenser driver. As the cash dispenser driver 70a has registered, the broker 76 provides the cash dispenser function request agent 72a with the contact identifier of the driver agent 70a from the register 124. Using this dispenser driver identifier, the cash dispenser function request agent 72a can communicate directly with the cash dispenser driver agent 70a to form an associated function request and driver pair.

In other embodiments, a separate small display driver agent may not be used, the display driver agent may be used to route information to a wireless device.

In other embodiments, when a portable wireless device is used, the small display driver agent and wireless input driver agent may cause the associated small display function request agent and wireless input function request agent to be instantiated. Alternatively, the broker may instantiate these function request agents.

What is claimed is:

1. A self-service terminal comprising:
a plurality of modules; and
a control application comprising a plurality of independent module control agents, and a logic engine;
each module control agent including means for requesting and managing functions provided by an associated module, so that the logic engine can execute a transaction by issuing successive requests to module control agents.

2. A terminal according to claim 1, wherein each module control agent comprises a module driver agent and a module function request agent.

3. A self-service terminal comprising:
a plurality of modules;
a control application comprising a plurality of module driver agents, a plurality of module function request agents for requesting functions provided by a module, and a logic engine; and
an interface between the driver agents and the function request agents, so that a module driver agent is operable to co-operate with an associated function request agent to provide module functions for the logic engine.

4. A terminal according to claim 3, further comprising health agents cooperating with driver agents and function request agents.

5. A terminal according to claim 3, wherein the logic engine is implemented by an agent having access to a set of rules.

6. A terminal according to claim 3, wherein the interface between the driver agents and the function request agents is implemented by a broker agent.

7. A terminal according to claim 6, wherein the driver agents are organised in a community of agents that register their functions with the broker agent.

8. A terminal according to claim 3, further comprising a gatekeeper driver agent for monitoring any user accessible communications port.

9. An automated teller machine (ATM) comprising:
a plurality of modules; and
a control application comprising a plurality of independent module control agents, and a logic engine;
each module control agent including means for requesting and managing functions provided by an associated module, so that the logic engine can execute a transaction by issuing successive requests to module control agents.

10. An ATM according to claim 9, wherein each module control agent comprises a module driver agent and a module function request agent.

11. An automated teller machine (ATM) comprising:
a plurality of modules;
a control application comprising a plurality of module driver agents, a plurality of module function request agents for requesting functions provided by a module, and a logic engine; and
an interface between the driver agents and the function request agents, so that a module driver agent is operable to co-operate with an associated function request agent to provide module functions for the logic engine.

12. An ATM according to claim 11, further comprising health agents co-operating with driver agents and function request agents.

13. An ATM according to claim 11, wherein the logic engine is implemented by an agent having access to a set of rules.

14. An ATM according to claim 11, wherein the interface between the driver agents and the function request agents is implemented by a broker agent.

15. An ATM according to claim 14, wherein the driver agents are organised in a community of agents that register their functions with the broker agent.

16. An ATM according to claim 11, further comprising a gatekeeper driver agent for monitoring any user accessible communications port.

17. A method of operating a self-service terminal having a plurality of modules, and having a control application, the method comprising the steps of:
providing a plurality of module driver agents, each module driver agent being operable to instruct a module to perform one or more functions;
providing a plurality of module function request agents for requesting functions provided by a module;
providing a logic engine; and
teaming a driver agent with a function request agent via an interface to provide module functions for the logic engine.
